(19) United States
(12) Patent Application Publication
(10) Pub. No.: US 2013/0043613 A1
(43) Pub. Date: Feb. 21, 2013

(54) Method for Producing Polyolefin Microporous Membrane

(71) Applicant: Shinya Kawasoe, Chiyoda-ku (JP)

(72) Inventor: Shinya Kawasoe, Chiyoda-ku (JP)

(21) Appl. No.: 13/510,204

(22) PCT Filed: Nov. 17, 2010
(86) PCT No.: PCT/JP2010/070450

§ 371 Date: Jun. 13, 2012

(30) Foreign Application Priority Data
Nov. 17, 2009 (JP) 2009-261933

(51) Int. Cl. B29C 67/20

(52) U.S. Cl. 264/49

(57) ABSTRACT

A method for producing a polyolefin microporous membrane, comprising the following steps (A) to (D):
(A) a kneading step of kneading a polyolefin resin, a plasticizer, and an antioxidant to form a kneaded material;
(B) a molding step of processing the kneaded material into a sheet-shaped molded form after the kneading step;
(C) a stretching step of stretching the sheet-shaped molded form to form a stretched material, after the molding step; and
(D) a porous sheet forming step of extracting the plasticizer from the stretched material to form a porous sheet, before and/or after the stretching step, wherein
   the step (A) is a step of kneading the plasticizer to which 0.05 to 5% by mass of the antioxidant based on the polyolefin resin is added, and the polyolefin resin.

### TECHNICAL FIELD

The present invention relates to a method for producing a polyolefin microporous membrane.

### BACKGROUND ART

Microporous membranes made of polyolefins are widely used for the separation of various substances and as selectively permeable separation membranes, separator materials, and the like. Examples of applications include microfiltration membranes, separators for fuel cells or capacitors, base materials for functional membranes in which pores are filled with a functional material to allow a new function to appear, or separators for batteries. Particularly, microporous membranes made of polyolefins are preferably used as separators for lithium ion batteries widely used in notebook personal computers, cellular phones, digital cameras, and the like. In addition, in the future, also in this field, which also attracts attention as separators for electric vehicles and hybrid electric vehicles, for mobile unit storage devices for electric motorcycles, electric bicycles, and the like, for uninterruptible power generators, and for stationary medium to large storage devices for systems, for regions, for home use, and the like, the expansion of the applications of microporous membranes made of polyolefins, as separators for lithium ion batteries, is expected.

As methods for producing polyolefin microporous membranes used for separators for lithium ion batteries, a dry process in which a single polyolefin resin film is stretched to form pores, and a wet process in which a mixture of a polyolefin resin, a plasticizer, and the like is subjected to phase separation when molded into a film shape, and the plasticizer and the like are extracted to form pores are common. In terms of the uniformity of the membrane, and the balance between strength and various physical properties, polyolefin microporous membranes manufactured by the wet process are widely used as separators for lithium ion batteries.

Here, conventionally, when a resin molded material is heated and melted and molded by an extruder or the like as described in Patent Literature 1, it is common to previously dry-blend an antioxidant in a resin powder or resin pellets, and extrude the resin, for the purpose of suppressing the oxidative degradation of the resin.

### CITATION LIST

### Patent Literature

Patent Literature 1: Japanese Patent No. 3917721

### SUMMARY OF INVENTION

### Technical Problem

However, when the present inventors manufactured a microporous membrane according to the method for producing a polyolefin microporous membrane described in the above Patent Literature 1, it was found that when long-time continuous operation is performed, oxidatively degraded materials, such as a resin, may adhere to a filter placed at the extruder outlet, the extruder interior, a gear pump, a piping wall, clearances in a piping connection portion and the like, the dead portion of a die, the tip portion of a die lip, and the like. These are called die-build-up or burned and may significantly decrease productivity by causing a decrease in the yield of the product and a decrease in the operating time of the apparatus due to the removal of these, requiring complicated disassembly and cleaning operations, and the like.

In view of the above circumstances, it is an object of the present invention to provide a method for producing a polyolefin microporous membrane that can suppress filter clogging in an extruder in long-time operation and has excellent long-time operability.

### Solution to Problem

The present inventors have diligently studied over and over to achieve the above-described object, and, as a result, found that filter clogging in an extruder is suppressed, and long-time operability can be improved by, in the step of kneading a polyolefin resin, which becomes the substrate of a microporous membrane, and a plasticizer to form a kneaded material, kneading the plasticizer comprising a particular amount of an antioxidant based on the polyolefin resin, and the polyolefin resin, leading to the completion of the present invention.

Specifically, the present invention is as follows:
[1] A method for producing a polyolefin microporous membrane, comprising the following steps (A) to (D):
(A) a kneading step of kneading a polyolefin resin, a plasticizer, and an antioxidant to form a kneaded material;
(B) a molding step of processing the kneaded material into a sheet-shaped molded form after the kneading step;
(C) a stretching step of stretching the sheet-shaped molded form to form a stretched material, after the molding step; and
(D) a porous sheet forming step of extracting the plasticizer from the stretched material to form a porous sheet, before and/or after the stretching step, wherein

the step (A) is a step of kneading the plasticizer to which 0.05 to 5% by mass of the antioxidant based on the polyolefin resin is added, and the polyolefin resin.
[2] The producing method according to [1], wherein the plasticizer comprises a recycled product of the plasticizer extracted from the stretched material in the step (D).
[3] The producing method according to [1] or [2], wherein the plasticizer comprises liquid paraffin as a main component.
[4] The producing method according to [3] or [4], wherein the liquid paraffin has a kinematic viscosity at 40° C. of 3.0×10⁻⁵ m²/s to 5.0×10⁻⁴ m²/s.
[5] The producing method according to [3] or [4], wherein the liquid paraffin has a flash point of 250° C. or higher.
[6] The producing method according to any of [1] to [5], wherein the polyolefin resin comprises polypropylene.
[7] The producing method according to any of [1] to [6], wherein the polyolefin resin comprises high density polyethylene.
[8] The producing method according to any of [1] to [7], wherein the polyolefin resin has a viscosity-average molecular weight of 50,000 or more and 10,000,000 or less.
[9] The producing method according to any of [1] to [8], wherein the polyolefin resin comprises an antioxidant.
[10] The producing method according to any of [1] to [9], wherein the antioxidant comprises a phenolic antioxidant as a main component.
[11] The producing method according to any of [1] to [10], wherein the kneading in the step (A) is performed under an inert gas atmosphere.

### Advantageous Effects of Invention

Filter clogging in an extruder after long-time operation is significantly suppressed by the method for producing a polyolefin microporous membrane according to the present invention, and therefore, it is possible to reduce the trouble of disassembling and cleaning the filter in the extruder and stably manufacture a polyolefin microporous membrane for a long period.

### DESCRIPTION OF EMBODIMENT

A mode for carrying out the present invention (hereinafter abbreviated as “this embodiment”) will be described in detail below. The present invention is not limited to the following embodiment, and various modifications can be made without departing from the spirit thereof.

In this embodiment, a “main component” means that the proportion of a particular component in a matrix component (including the particular component) is preferably 50% by mass or more, more preferably 70% by mass or more, and further preferably 90% by mass or more, and may be 100% by mass.

A method for producing a polyolefin microporous membrane in this embodiment comprises the following steps (A) to (D):
(A) a kneading step of kneading a polyolefin resin, a plasticizer, and an antioxidant to form a kneaded material;
(B) a molding step of processing the above kneaded material into a sheet-shaped molded form after the above kneading step;
(C) a stretching step of stretching the above sheet-shaped molded form to form a stretched material, after the above molding step; and
(D) a porous sheet forming step of extracting the plasticizer from the above stretched material to form a porous sheet, before and/or after the above stretching step, and

the above step (A) is the step of kneading the plasticizer to which 0.05 to 5% by mass of the antioxidant based on the above polyolefin resin is added (contained), and the polyolefin resin.

### [Step (A)]

The step (A) in the producing method in this embodiment is a kneading step of kneading a polyolefin resin, a plasticizer, and an antioxidant to form a kneaded material. The kneading step is preferably performed under an inert gas atmosphere.

Examples of the polyolefin resin used in the step (A) include polymers (homopolymers, copolymers, multistage polymers, and the like) obtained by polymerizing monomers, such as ethylene, propylene, 1-butene, 4-methyl-1-pentene, 1-hexene, and 1-octene. One of these polymers can be used alone, or two or more can be used in combination.

In addition, as the above polyolefin resin, for example, low density polyethylene, linear low density polyethylene, medium density polyethylene, high density polyethylene, ultrahigh molecular weight polyethylene, polypropylene (isotactic polypropylene, atactic polypropylene, and the like), polybutene, ethylene propylene rubber, and the like may be used.

Here, in terms of decreasing the melting point of the polyolefin microporous membrane or improving the piercing strength, the above polyolefin resin preferably comprises high density polyethylene. The density of high density polyethylene is generally 0.940 g/cm³ or more.

The proportion of high density polyethylene in the above polyolefin resin is preferably 10% by mass or more, more preferably 30% by mass or more, and further preferably 50% by mass or more, and may be 100% by mass.

In addition, in terms of improving the heat resistance of the polyolefin microporous membrane, the above polyolefin resin preferably comprises polypropylene.

The proportion of polypropylene in the above polyolefin resin is preferably 1% by mass or more, more preferably 5% by mass or more, and is preferably 20% by mass or less, further preferably 10% by mass or less, as the upper limit. Setting the proportion to 1% by mass or more is preferred in terms of improving the heat resistance of the polyolefin microporous membrane. Setting the proportion to 20% by mass or less is preferred in terms of achieving a microporous membrane having good stretchability and excellent air permeability.

The viscosity-average molecular weight of the above polyolefin resin (a value measured for each polyolefin resin is meant when a plurality of polyolefin resins are used) is preferably 50,000 or more, more preferably 100,000 or more, and further preferably 300,000 or more, and is preferably 10,000,000 or less, more preferably 3,000,000 or less, as the upper limit. Setting the viscosity-average molecular weight to 50,000 or more is preferred in terms of maintaining high melt tension in melting and molding to ensure good moldability or providing sufficient entanglement to increase the strength of the microporous membrane. On the other hand, setting the viscosity-average molecular weight to 10,000,000 or less is preferred in terms of achieving uniform melting and kneading to improve the moldability, particularly thickness stability, of the sheet. Setting the viscosity-average molecular weight to 3,000,000 or less is preferred in terms of further improving the moldability.

In terms of the balance of the physical properties of the polyolefin microporous membrane and an improvement in its moldability, several polyolefins having different viscosity-average molecular weights may be mixed and used.

The proportion of the above polyolefin resin in the above kneaded material is preferably 20% by mass or more, more preferably 30% by mass or more, in terms of film strength, and is preferably 70% by mass or less, preferably 60% by mass or less, as the upper limit, in terms of ensuring porosity.

In addition, in the above step (A), an inorganic filler may be mixed as required, and all or part of the above inorganic filler may be removed by a method such as extraction in a subsequent step.

The plasticizer used in the step (A) is preferably a nonvolatile solvent that can form a uniform solution at the melting point of the polyolefin resin or higher when mixed with the polyolefin resin. In addition, the plasticizer is preferably liquid at ordinary temperature, but when the plasticizer is solid, it can also be used by heating and melting. Here, the plasticizer used in the step (A) may comprise a recycled product of the plasticizer extracted from the stretched material in the step (D) described later.

Examples of the above plasticizer include hydrocarbons, such as liquid paraffin and paraffin wax; esters, such as diethylhexyl phthalate and dibutyl phthalate; and higher alcohols, such as oleyl alcohol and stearyl alcohol. These may be used singly or mixed and used.

Particularly, in the plasticizer, liquid paraffin is preferably used as the main component. Liquid paraffin can suppress the interface debonding between the polyolefin resin and the plasticizer to carry out uniform stretching, or can achieve the high piercing strength of the obtained microporous membrane.

The viscosity of the liquid paraffin is preferably 3.0×10⁻⁵ m²/s to 5.0×10⁻⁴ m²/s, more preferably 4.0×10⁻⁵ m²/s to 1.0×10⁻⁴ m²/s, and further preferably 6.5 to 8.0×10⁻⁵ m²/s. The viscosity of the liquid paraffin being 3.0×10⁻⁵ m²/s or more or 5.0×10⁻⁴ m²/s or less is preferred in terms of mixing properties with the polyolefin resin. Here, the viscosity of the liquid paraffin indicates kinematic viscosity at 40° C. measured according to JIS K2283.

The flash point of the liquid paraffin is preferably 250° C. or higher, more preferably 260° C. or higher. The flash point of the liquid paraffin being 250° C. or higher means a small amount of low molecular weight components in the liquid paraffin and is preferred in terms of being able to reduce the risk that the antioxidant bleeds out in the membrane producing process, though also depending on the amount of the contained antioxidant, and being able to suppress contamination in the steps and a decrease in productivity.

Here, the flash point of the liquid paraffin can be measured by Cleveland open cup flash point measurement.

The proportion of the above plasticizer in the above kneaded material is preferably 30% by mass or more, more preferably 40% by mass or more, and is preferably 80% by mass or less, preferably 70% by mass or less, as the upper limit. Setting the proportion to 80% by mass or less is preferred in terms of maintaining high melt tension during melting and molding to ensure moldability. On the other hand, setting the proportion to 30% by mass or more is preferred in terms of ensuring moldability and efficiently stretching lamellar crystals in the crystalline regions of the polyolefin. Here, the lamellar crystals being efficiently stretched means the polyolefin chains being efficiently stretched without breaking the polyolefin chains and can contribute to the formation of uniform and fine pore structures and an improvement in the strength and degree of crystallinity of the polyolefin microporous membrane.

In the producing method in this embodiment, when the antioxidant is separately added, the antioxidant is contained in the plasticizer before the polyolefin resin and the plasticizer are kneaded. In other words, the antioxidant is contained in the plasticizer in the step (A) in the proportion of 0.05 to 5% by mass based on the polyolefin resin.

It is considered that by kneading the plasticizer and the polyolefin resin with a particular amount of the antioxidant contained in the plasticizer, the antioxidant is more easily uniformly dispersed in the resin kneaded material. It is considered that as a result, the clogging of a filter in an extruder when the kneaded material is extruded into a sheet shape is reduced, and filter clogging after long-time operation can be significantly suppressed.

Setting the amount of the antioxidant contained in the plasticizer to 0.05% by mass or more based on the polyolefin resin is preferred in terms of being able to exhibit the effect of suppressing the oxidative degradation of the polyolefin resin at a higher level, suppress the occurrence of clogging and a change in molecular weight, and suppress a decrease in productivity. In addition, setting the amount of the antioxidant to 5% by mass or less is preferred in terms of being able to reduce the risk that the antioxidant bleeds out in the membrane producing process and being able to suppress contamination in the steps and a decrease in productivity. The content of the antioxidant is preferably 0.3% by mass or more based on the polyolefin resin, and, on the other hand, is preferably 1% by mass or less as the upper limit.

The antioxidant is not particularly limited, but, for example, preferably comprises a phenolic antioxidant, which is a primary antioxidant, as the main component. Specific examples of the phenolic antioxidant include 2,6-di-t-butyl-4-methylphenol, pentaerythrityl-tetrakis-[3-(3,5-di-t-butyl-4-hydroxyphenyl)propionate], and octadecyl-3-(3,5-di-t-butyl-4-hydroxyphenyl)propionate. A secondary antioxidant can also be used in combination. Specific examples of the secondary antioxidant include phosphorus-based antioxidants, such as tris(2,4-di-t-butylphenyl)phosphite and tetrakis(2,4-di-t-butylphenyl)-4,4-biphenylene-diphosphonite, and sulfur-based antioxidants, such as dilauryl-thio-dipropionate.

One of these can be used alone, or two or more can also be used in combination.

In the step (A), apart from the particular amount of the antioxidant contained in the plasticizer, the above-described antioxidant may be contained in the polyolefin resin. In this case, it is preferred that the total of the content of the antioxidant in the polyolefin resin and the amount of the antioxidant contained in the plasticizer is 5% by weight or less based on the polyolefin resin.

Examples of the method for kneading the polyolefin resin, the plasticizer, and the antioxidant include the following methods (a) and (b):
(a) A method of charging the polyolefin resin into a resin kneading apparatus, such as an extruder or a kneader, and further introducing and kneading the plasticizer and the antioxidant while heating, melting, and kneading the resin.
(b) A method of, after undergoing the step of previously kneading the polyolefin resin, the plasticizer, and the antioxidant in a predetermined proportion beforehand using a Henschel mixer or the like, charging the kneaded material into an extruder, and further introducing and kneading the plasticizer with heating and melting.

The above kneading is preferably performed under an inert gas atmosphere. The above inert gas is a concept widely including gases having low chemical reactivity and includes nitrogen gas, carbonic acid gas, helium gas, and argon gas. Among them, nitrogen gas is preferred.

In addition, examples of the method for performing the above kneading under an inert gas atmosphere include the following methods (c) and (d):
(c) A method of placing a charging apparatus for charging the resin into the kneading apparatus, itself, under an inert gas atmosphere. A method of subjecting the resin flow path to vacuum degassing replacement is also preferred.
(d) A method of injecting an inert gas into the resin flow path to the extent that the resin is not blown up, when charging the resin into the kneading apparatus. The injection speed is preferably 0.1 L/min to 100 L/min, more preferably 10 L/min to 60 L/min.

### [Step (B)]

The step (B) in the producing method in this embodiment is a molding step of processing the above kneaded material into a sheet-shaped molded form after the above kneading step.

The step (B) is, for example, the step of extruding the above kneaded material into a sheet shape through a T-die, a ring die, or the like and bringing the sheet-shaped extruded material into contact with a heat conductor to cool and solidify it, after the above step (A). As the heat conductor, metal, water, air, the plasticizer itself, or the like can be used. In addition, performing cooling and solidification by sandwiching between rolls is preferred in terms of increasing the film strength of the sheet-shaped molded form and improving the surface smoothness of the sheet-shaped molded form.

### [Step (C)]

The step (C) in the producing method in this embodiment is a stretching step of stretching the above sheet-shaped molded form to form a stretched material, after the above molding step.

Examples of the stretching method in the above step (C) include methods such as simultaneous biaxial stretching, sequential biaxial stretching, multistage stretching, and many times stretching. Using the simultaneous biaxial stretching method, among them, is preferred in terms of an increase in the piercing strength of the polyolefin microporous membrane and uniform film thickness.

In addition, the area ratio in the above step (C) is preferably 20 times or more, more preferably 25 times or more in order to keep moderate mechanical strength, and is preferably 200 times or less, more preferably 100 times or less, and further preferably 50 times or less, as the upper limit, in terms of economy and stability.

With the melting point temperature of the polyolefin resin being used as the reference temperature, the stretching temperature in the above step (C) is preferably the melting point temperature −50° C. or higher, more preferably the melting point temperature −30° C. or higher, and further preferably the melting point temperature −20° C. or higher, and is preferably the melting point temperature −2° C. or lower, more preferably the melting point temperature −3° C. or lower, as the upper limit. Setting the stretching temperature to the melting point temperature −50° C. or higher is preferred in terms of adhering the interface between the polyolefin resin and the plasticizer well to improve compression resistance performance in the local and minute regions of the polyolefin microporous membrane. For example, when high density polyethylene is used as the polyolefin resin, the stretching temperature is preferably 115° C. or higher and 132° C. or lower. When a plurality of polyolefins are mixed and used, the melting point of a polyolefin having a larger amount of heat of fusion can be used as the reference.

### [Step (D)]

The step (D) in the producing method in this embodiment is a porous sheet forming step of extracting the plasticizer from the above stretched material to form a porous sheet, before and/or after the above stretching step.

The step (D) can be carried out before and/or after the step (C), but is preferably performed after the above step (C) in terms of improving the piercing strength of the polyolefin microporous membrane. Examples of the extraction method include a method of immersing the above stretched material in an extraction solvent for the plasticizer described later, and a method of shower washing. The amount of the remaining plasticizer in the microporous membrane after the extraction is preferably less than 1% by mass.

As the extraction solvent in the step (D), a solvent that is a poor solvent for the polyolefin constituting the membrane and is a good solvent for the plasticizer and has a boiling point lower than the melting point of the polyolefin constituting the membrane is preferred. Examples of such an extraction solvent include hydrocarbons, such as n-hexane and cyclohexane; halogenated hydrocarbons, such as methylene chloride and 1,1,1-trichloroethane; non-chlorine-based halogenated solvents, such as hydrofluoroether and hydrofluorocarbon; alcohols, such as ethanol and isopropanol; ethers, such as diethyl ether and tetrahydrofuran; and ketones, such as acetone and methyl ethyl ketone. From these, one or more are appropriately selected and used alone or mixed and used. Among them, methylene chloride and methyl ethyl ketone are preferred. In terms of economy, the solvent, the plasticizer, and the antioxidant recovered in the step (D) may be recycled. For the recovered solvent, plasticizer, and antioxidant, the solvent can be particularly preferably used in the step (D) as a recycled product, and the plasticizer and the antioxidant can be particularly preferably used in the step (A) as recycled products. Examples of the method of recovery include a method of separating and recovering the extraction solvent, the plasticizer, and the like from the mixture of the extraction solvent, the plasticizer, and the like by distillation, phase separation, filtration, or the like.

In addition, the method for producing a polyolefin microporous membrane in this embodiment may comprise (E) a step of heat-fixing the above porous sheet after the above porous sheet forming step, as required.

Here, examples of the method of heat fixation in the step (E) include a method of performing stretching and relaxation operations and the like using a tenter or a roll stretching machine. As the stretching ratio in the step (E), the area ratio is preferably less than 4 times. The stretching operation may be performed in both of the MD (the machine direction, which means the resin discharge direction) and the TD (the direction orthogonal to the MD, which means the membrane width direction), or only the stretching operation in only one of the MD or the TD may be performed. In addition, the relaxation operation is a reduction operation that is performed in the MD and/or TD of the membrane at a certain relaxation rate. The relaxation rate is 3% or more, more preferably 3 to 50%, in terms of membrane producing properties and heat shrinkage. For example, when high density polyethylene is used, the temperature is preferably 100° C. or higher in terms of heat shrinkage rate and is preferably lower than 135° C. in terms of porosity and transmissiveness. The relaxation operation may be performed in both of the MD and the TD, but even in the relaxation operation in only one of the MD or the TD, the heat shrinkage rate can be reduced not only in the operation direction but also in the direction perpendicular to the operation.

After the above step (E), the obtained polyolefin microporous membrane may be subjected to post-treatment. Examples of such post-treatment include hydrophilization treatment with a surfactant or the like, and crosslinking treatment with ionizing radiation or the like.

The above-described various parameters are measured according to measurement methods in Examples described later unless otherwise specified.

### EXAMPLES

Next, this embodiment will be described more specifically by giving Examples and Comparative Examples, but this embodiment is not limited to the following Examples unless departing from the spirit thereof. The physical properties in the Examples were measured by the following methods.

### (1) Molecular Weight (Mv, Viscosity-Average Molecular Weight)

For the viscosity-average molecular weight of polyethylene and polyolefin raw materials and microporous membranes, measurement was performed at a measurement temperature of 135° C. using decalin as a solvent, and the viscosity-average molecular weight was calculated from viscosity [η] by the following formula: [η]=6.77×10⁻⁴ Mv^{0.67} (Chiang's formula)

In addition, for polypropylene, My was calculated by the following formula: [η]=1.10×10⁻⁴ Mv^{0.80}

### (2) Clogging of Screen (Long-Time Operability Evaluation)

⊚: Production was continuously performed in 24-hour operation for 10 days. An increase in screen pressure at an extruder outlet during this time was monitored, and a screen (250 mesh) after 10 days was checked. Little adhering materials (clogging) were observed.
◯: The amount of clogging adhering to the screen was slightly larger than that of the above example of “⊚” but was not at a level that hinders operation.
×: On the 8th day from the start of operation, continuous operation became impossible due to an increase in screen pressure at the extruder outlet.

××: On the 6th day from the start of operation, continuous operation became impossible due to an increase in screen pressure at the extruder outlet.

×××: On the 3rd day from the start of operation, continuous operation became impossible due to an increase in screen pressure at the extruder outlet.

### (3) Soil on Roll

The amount of an antioxidant adhering to a cooling roll in the step (B) after 24 hours from the start of production was visually classified into ⊚: no, ◯: substantially no, Δ: a small amount of adhesion, or ×: a large amount of adhesion for evaluation.

### Example 1

A high density polyethylene (0.95 g/cm³) powder having a viscosity-average molecular weight of 300,000 was fed from a feeder to a corotating twin screw extruder having a screw diameter of 58 mm under a nitrogen atmosphere. As the method for providing a nitrogen atmosphere, a method of injecting nitrogen gas into the feed port of the above extruder for the above polyethylene powder at 30 L/min was used.

In addition, a solution obtained by previously adding and dissolving 1% by mass of pentaerythrityl-tetrakis-[3-(3,5-di-t-butyl-4-hydroxyphenyl)propionate] as an antioxidant, based on the polymer, in liquid paraffin (having a kinematic viscosity of 7.59×10⁻⁵ m²/s at 37.78° C., a kinematic viscosity of 6.79×10⁻⁵ m²/s at 40.00° C., and a flash point of 252° C.) was injected into an extruder cylinder by a plunger pump.

The mixture was melted and kneaded, and the feeder and the pump were adjusted so that the ratio of the amount of the liquid paraffin in the entire mixture extruded was 70% by mass (that is, the polymer concentration was 30% by mass). For the melting and kneading conditions, the set temperature was 220° C., and melting and kneading were performed at a screw revolution number of 240 rpm and a discharge amount of 60 kg/h. Then, the melted and kneaded material was extruded and cast on a cooling roll through a T-die to obtain a gel sheet. Next, this gel sheet was guided to a simultaneous biaxial tenter stretching machine to perform biaxial stretching, then this sheet was guided to a methylene chloride vessel to remove the liquid paraffin by extraction, and then, methylene chloride was removed by drying. Further, this sheet was guided to a TD tenter and stretched at a low ratio, and further subjected to a relaxation operation to continuously produce a microporous membrane of polyethylene.

### Example 2

A microporous membrane of polyethylene was continuously produced as in Example 1 except that the amount of the antioxidant added was 0.07% by mass based on the polymer.

### Example 3

A microporous membrane of polyolefins was continuously produced as in Example 1 except that 48% by mass of a high density polyethylene homopolymer having a viscosity-average molecular weight of 250,000 and a melting point of 134° C., 47% by mass of a high density polyethylene homopolymer having a viscosity-average molecular weight of 600,000 and a melting point of 134° C., and 5% by mass of a polypropylene homopolymer having a viscosity-average molecular weight of 400,000 were dry-blended using a tumbler blender to provide a raw material powder.

### Example 4

A microporous membrane of polyethylene was continuously produced as in Example 2 except that the amount of the antioxidant added, corresponding to 0.03% by mass based on the polymer, was separately added to the raw material powder.

### Example 5

A microporous membrane of polyethylene was continuously produced as in Example 1 except that as the liquid paraffin, one having a kinematic viscosity of 7.73×10⁵ m²/s at 37.78° C., a kinematic viscosity of 6.93×10⁻⁵ m²/s at 40.00° C., and a flash point of 238° C. was used.

### Example 6

A microporous membrane of polyethylene was continuously produced as in Example 1 except that as the liquid paraffin, one having a kinematic viscosity of 7.22×10⁻⁵ m²/s at 40.00° C. and a flash point of 274° C. was used.

### Comparative Example 1

A microporous membrane of polyethylene was continuously produced as in Example 1 except that the amount of the antioxidant added, in the liquid paraffin, was 0.04% by mass based on the polymer.

The Mv of the obtained microporous membrane decreased to 200,000.

### Comparative Example 2

A microporous membrane of polyethylene was continuously produced as in Example 1 except that no antioxidant was added to the liquid paraffin.

The Mv of the obtained microporous membrane decreased to 100,000.

### Comparative Example 3

1% by mass of pentaerythrityl-tetrakis-[3-(3,5-di-t-butyl-4-hydroxyphenyl)propionate] as an antioxidant was added to 100% by mass of polyethylene having an Mv of 300,000, and they were dry-blended using a tumbler blender to obtain a mixture of the polymer and the like. After replacement with nitrogen was performed, the obtained mixture of the polymer and the like was fed to a twin screw extruder by a feeder under a nitrogen atmosphere. As the method for providing a nitrogen atmosphere, a method of injecting nitrogen gas into the feed port of the above extruder for the above polyethylene powder at 30 L/min was used.

In addition, liquid paraffin (having a kinematic viscosity of 7.59×10⁻⁵ m²/s at 37.78° C.) was injected into an extruder cylinder by a plunger pump. The mixture was melted and kneaded, and the feeder and the pump were adjusted so that the ratio of the amount of the liquid paraffin in the entire mixture extruded was 30% by mass. For the melting and kneading conditions, the set temperature was 220° C., and melting and kneading were performed at a screw revolution number of 240 rpm and a discharge amount of 60 kg/h. The subsequent operations were performed as in Example 1 to continuously produce a microporous membrane of polyethylene.

### Reference Example

A microporous membrane of polyethylene was continuously produced as in Example 1 except that a nitrogen atmosphere was not provided when the raw material powder was fed to the twin screw extruder.

### Comparative Example 4

A microporous membrane of polyethylene was continuously produced as in Example 1 except that the amount of the antioxidant added, in the liquid paraffin, was 6% by mass based on the polymer.

TABLE 1

| | | Example 1 | Example 2 | Example 3 | Example 4 | Example 5 | Example 6 |
|---|---|---|---|---|---|---|---|
| Antioxidant | Whether mixed | ◯ | ◯ | ◯ | ◯ | ◯ | ◯ |
| in liquid | or not | | | | | | |
| paraffin | wt % | 0.43 | 0.03 | 0.43 | 0.03 | 0.43 | 0.43 |
| Liquid | Flash point (° C.) | 252 | 252 | 252 | 252 | 238 | 274 |
| paraffin | | | | | | | |
| Antioxidant | Whether mixed | X | X | X | ◯ | X | X |
| in resin | or not | | | | | | |
| Inert gas | Whether purged | ◯ | ◯ | ◯ | ◯ | ◯ | ◯ |
| | or not | | | | | | |
| Polymer | % | 30 | 30 | 30 | 30 | 30 | 30 |
| concentration | | | | | | | |
| Amount of | wt % | 1 | 0.07 | 1 | 1 | 1 | 1 |
| antioxidant | | | | | | | |
| mixed, based | | | | | | | |
| on polyolefin | | | | | | | |
| resin | | | | | | | |
| Evaluation | Clogging of | ⊚ | ◯ | ⊚ | ◯ | ⊚ | ⊚ |
| | screen | | | | | | |
| | Molecular | 270,000 | 270,000 | 430,000 | 270,000 | 270,000 | 270,000 |
| | weight (Mv) of | | | | | | |
| | obtained | | | | | | |
| | microporous | | | | | | |
| | membrane (Mw) | | | | | | |
| | Soil on roll | ◯ | ◯ | ◯ | Δ | ◯-Δ | ⊚ |

| | | Comparative | Comparative | Comparative | Reference | Comparative |
|---|---|---|---|---|---|---|
| | | Example 1 | Example 2 | Example 3 | Example | Example 4 |
| Antioxidant | Whether mixed | ◯ | X | X | ◯ | ◯ |
| in liquid | or not | | | | | |
| paraffin | wt % | 0.02 | 0 | 0 | 0.43 | 2.57 |
| Liquid | Flash point (° C.) | 252 | 252 | 252 | 252 | 252 |
| paraffin | | | | | | |
| Antioxidant | Whether mixed | X | X | ◯ | X | X |
| in resin | or not | | | | | |
| Inert gas | Whether purged | ◯ | ◯ | ◯ | X | ◯ |
| | or not | | | | | |
| Polymer | % | 30 | 30 | 30 | 30 | 30 |
| concentration | | | | | | |
| Amount of | wt % | 0.04 | 0 | 1 | 1 | 6 |
| antioxidant | | | | | | |
| mixed, based | | | | | | |
| on polyolefin | | | | | | |
| resin | | | | | | |
| Evaluation | Clogging of | X | XXX | XX | X | ⊚ |
| | screen | | | | | |
| | Molecular | 200,000 | 100,000 | 250,000 | 200,000 | 270,000 |
| | weight (Mv) of | | | | | |
| | obtained | | | | | |
| | microporous | | | | | |
| | membrane (Mw) | | | | | |
| | Soil on roll | ◯ | ◯ | Δ | ◯ | X |

As is clear from the results in Table 1, the method for producing a polyolefin microporous membrane in this embodiment suppressed filter clogging in the extruder also after long-time operation and had excellent long-time operability.

This application is based on Japanese Patent Application No. 2009-261933 filed with the Japan Patent Office on Nov. 17, 2009, the content of which is incorporated herein by reference.

### INDUSTRIAL APPLICABILITY

Filter clogging in an extruder after long-time operation is significantly suppressed by the method for producing a polyolefin microporous membrane according to the present invention, and therefore, it is possible to reduce the trouble of disassembling and cleaning the filter in the extruder and stably manufacture a polyolefin microporous membrane for a long period.

A polyolefin microporous membrane obtained by the producing method of the present invention has industrial applicability as separators for electrochemical reaction apparatuses, such as batteries, capacitors, and fuel cells, and filtration membranes for removing viruses and impurities.

1. A method of producing a polyolefin microporous membrane, comprising the following steps (A) to (D):
(A) a kneading step of kneading a polyolefin resin, a plasticizer, and an antioxidant to form a kneaded material;
(B) a molding step of processing the kneaded material into a sheet-shaped molded form after the kneading step;
(C) a stretching step of stretching the sheet-shaped molded form to form a stretched material, after the molding step; and
(D) a porous sheet forming step of extracting the plasticizer from the stretched material to form a porous sheet, before and/or after the stretching step, wherein
the step (A) is a step of kneading the plasticizer to which 0.05 to 5% by mass of the antioxidant based on the polyolefin resin is added, and the polyolefin resin.

2. The method according to claim 1, wherein the plasticizer comprises a recycled product of the plasticizer extracted from the stretched material in the step (D).

3. The method according to claim 1 or 2, wherein the plasticizer comprises liquid paraffin as a main component.

4. The method according to claim 3, wherein the liquid paraffin has a kinematic viscosity at 40° C. of 3.0×10⁻⁵ m²/s to 5.0×10⁻⁴ m²/s.

5. The method according to claim 3, wherein the liquid paraffin has a flash point of 250° C. or higher.

6. The method according to claim 1 or 2, wherein the polyolefin resin comprises polypropylene.

7. The method according to claim 1 or 2, wherein the polyolefin resin comprises high density polyethylene.

8. The method according to claim 1 or 2, wherein the polyolefin resin has a viscosity-average molecular weight of 50,000 or more and 10,000,000 or less.

9. The producing method according to claim 1 or 2, wherein the polyolefin resin comprises an antioxidant.

10. The producing method according to claim 1 or 2, wherein the antioxidant comprises a phenolic antioxidant as a main component.

11. The producing method according to claim 1 or 2, wherein the kneading in the step (A) is performed under an inert gas atmosphere.
